(19) United States
(12) Patent Application Publication
(10) Pub. No.: US 2011/0171087 A1
(43) Pub. Date: Jul. 14, 2011

(54) Pipette System, Pipette Tip Assembly and Kit

(75) Inventor: Yves A. Delmotte, Neufmaison (BE)

(73) Assignees: BAXTER INTERNATIONAL INC., Deerfield, IL (US); BAXTER HEALTHCARE S.A., Glattpark (Opfikon) (CH)

(21) Appl. No.: 12/985,739

(22) Filed: Jan. 6, 2011

Related U.S. Application Data
(60) Provisional application No. 61/294,004, filed on Jan. 11, 2010.

(51) Int. Cl. B01L 3/02

(52) U.S. Cl. 422/514

(57) ABSTRACT

A pipette tip assembly includes a pipette tip having a first open end adapted to receive a pipette tip mounting shaft of a pipette, a second open end, and an open channel therebetween. The assembly also includes a mixer disposed in the channel, the mixer including at least one porous mixing device. The at least one porous mixing device includes a three-dimensional lattice defining a plurality of tortuous, interconnecting passages therethrough, and has physical characteristics to sufficiently mix first and second fluids drawn or expelled through the mixer, which characteristics include a selected one or more of mean flow pore size, thickness and porosity.

This application claims the benefit of U.S. Application No. 61/294,004, filed Jan. 11, 2010, which is hereby incorporated by reference in its entirety herein.

### BACKGROUND

This patent relates to a system for mixing at least two components. In particular, this patent relates to a system for mixing and dispensing at least two components via a pipette using a mixer disposed in a pipette tip.

Use of pipettes for the transfer and dispensing of fluid samples in analytical systems is well known, as is the use of disposable pipette tips for such pipettes. Disposable tips accommodate the serial use of such pipettes in the transfer of different fluid samples without carryover or contamination.

Generally speaking, disposable pipette tips are formed of a plastic material and are of a hollow elongated tubular shape. An open proximal end of such pipette tips is designed to receive and releasably mate with a lower end of a pipette tip mounting shaft of a pipette while a distal end is of reduced cross section and includes a relatively small open end for passing fluids into and out of the pipette tip in response to operation of the associated pipette.

Currently, when it is desired to mix two or more fluids that have been drawn into a pipette tip, the fluids must be agitated, for example by applying a swirling motion or a shaking motion to the tip. Alternatively, the tip of the pipette may be inverted. As a still further alternative, a vortexer may be applied to the tip or to a container into which both fluids have been transferred, or a stirrer may be introduced into a container into which both fluids have been transferred.

As set forth in more detail below, the present disclosure sets forth an improved assembly embodying advantageous alternatives to the conventional devices and approaches discussed above.

### SUMMARY

According to an aspect of the present disclosure, a pipette tip assembly includes a pipette tip having a first open end adapted to receive a pipette tip mounting shaft of a pipette, a second open end, and an open channel therebetween. The assembly also includes a mixer disposed in the channel, the mixer including at least one porous mixing device. The at least one porous mixing device includes a three-dimensional lattice defining a plurality of tortuous, interconnecting passages therethrough, and has physical characteristics to sufficiently mix first and second fluids drawn or expelled through the mixer, which characteristics include a selected one or more of mean flow pore size, thickness and porosity.

According to another aspect of the present disclosure, a pipette system includes a pipette having a pipette tip mounting shaft and a pipette tip assembly. The assembly includes a pipette tip having a first open end in which the pipette tip mounting shaft is disposed, a second open end, and a channel therebetween. The assembly also includes a mixer disposed in the channel, the mixer including at least one porous mixing device. The at least one porous mixing device includes a three-dimensional lattice defining a plurality of tortuous, interconnecting passages therethrough, and has physical characteristics to sufficiently mix first and second fluids drawn or expelled through the mixer, which characteristics include a selected one or more of mean flow pore size, thickness and porosity.

According to still another aspect of the present disclosure, a kit includes a pipette having a pipette tip mounting shaft, and a pipette tip assembly. The assembly includes a pipette tip having a first open end adapted to receive the pipette tip mounting shaft, a second open end, and a channel therebetween. The assembly also includes a mixer disposed in the channel, the mixer including at least one porous mixing device. The at least one porous mixing device includes a three-dimensional lattice defining a plurality of tortuous, interconnecting passages therethrough, and has physical characteristics to sufficiently mix first and second fluids drawn or expelled through the mixer, which characteristics include a selected one or more of mean flow pore size, thickness and porosity.

Additional aspects of the disclosure are defined by the claims of this patent.

### BRIEF DESCRIPTION OF THE FIGURES

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a side view of a manual pipette having a disposable pipette tip assembly mounted adjacent a lower end of a tip ejector mechanism for the pipette;

FIG. 2 is a perspective view of an embodiment of a pipette tip assembly for use with the manual pipette of FIG. 1;

FIG. 3 is an enlarged fragmentary cross-sectional view of the pipette tip assembly of FIG. 2 taken along line 3-3;

FIG. 4 is an enlarged fragmentary cross-sectional view of an alternative pipette tip assembly, which tip assembly includes a different porous mixer than used in FIG. 3;

FIG. 5 is an enlarged fragmentary cross-sectional view of an alternative pipette tip assembly, which tip assembly includes a different porous mixer than used in FIG. 3;

FIG. 6 is a scanning electron picture showing a lateral cross section of a sintered polypropylene material having a width of approximately 8.0 millimeters (mm) and a thickness of about 1.0 mm at about ×30 magnification;

FIG. 7 is a scanning electron picture showing a lateral cross section of a sintered polypropylene material having a width of approximately 8.0 millimeters (mm) and a thickness of about 1.0 mm at about ×100 magnification;

FIG. 8 is a scanning electron picture showing a lateral cross section of a sintered polypropylene material having a width of approximately 8.0 millimeters (mm) and a thickness of about 1.0 mm at about ×350 magnification;

FIG. 9 is a scanning electron picture showing a lateral cross section of a sintered polypropylene material having a width of approximately 8.0 millimeters (mm) and a thickness of about 1.0 mm at about ×200 magnification;

FIG. 10 is a scanning electron picture showing a longitudinal cross section of a sintered polypropylene material having a width of approximately 8.0 millimeters (mm) and a thickness of about 1.0 mm at about ×30 magnification;

FIG. 11 is a scanning electron picture showing a longitudinal cross section of a sintered polypropylene material having a width of approximately 8.0 millimeters (mm) and a thickness of about 1.0 mm at about ×100 magnification;

FIG. 12 is a scanning electron picture showing a longitudinal cross section of a sintered polypropylene material having a width of approximately 8.0 millimeters (mm) and a thickness of about 1.0 mm at about ×250 magnification;

FIG. 13 is a scanning electron picture showing a longitudinal cross section of a sintered polypropylene material having a width of approximately 8.0 millimeters (mm) and a thickness of about 1.0 mm at about ×350 magnification; and

FIG. 14 shows porosity measurements of a selected material, of sintered polypropylene, obtained using a mercury porosity test.

### DETAILED DESCRIPTION

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

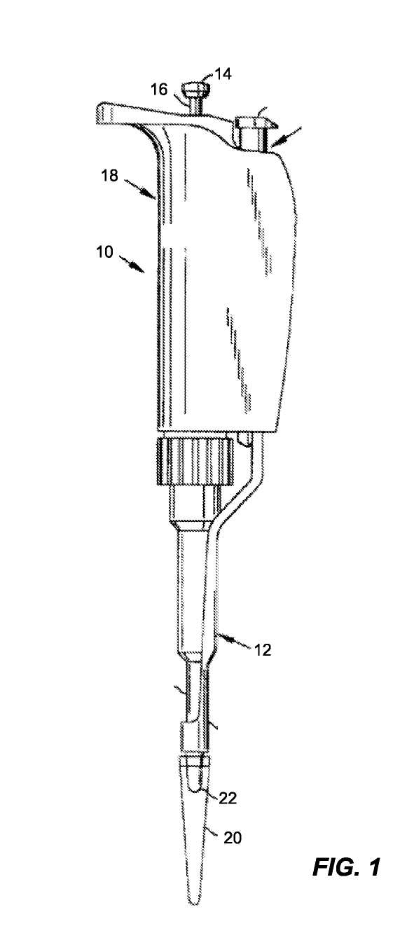

FIG. 1 illustrates a manual pipette 10, resembling the PIPETMAN pipette sold in the United States by the Rainin Instrument Co., Inc. The manual pipette 10 may include a pipette tip ejector mechanism 12 as has been described in the U.S. Pat. No. 5,614,153, which is hereby incorporated by reference herein.

The pipette 10 has a push button 14 connected by a rod 16 to piston (not shown) located in the body or housing 18 of the pipette. The push button 14 may be depressed by a user exerting a downward force on the push button 14 to cause downward motion of the piston of the pipette 10. When the push button 14 is released, a quantity of liquid to be sampled is aspirated or drawn into a disposable tip assembly 20 releasably secured to a lower end of a pipette tip mounting shaft 22 of the pipette 10. In aspirating the fluid into the pipette tip assembly 20, the pipette 10 may generate a maximum vacuum pressure, theoretically as high as 14.7 psi.

The sample then may be dispensed or transferred into another vessel by once more exerting a downward force on the push button 14. After such use, the pipette tip assembly 20 may be ejected from the mounting shaft 22 and replaced with a new pipette tip assembly 20 for repeated operation of the pipette 10 in aspirating and dispensing a new sample fluid. Alternatively, as described in greater detail below, a single pipette tip assembly 20 may be used to draw fluids from different containers, to mix the fluids, and then dispense the fluids.

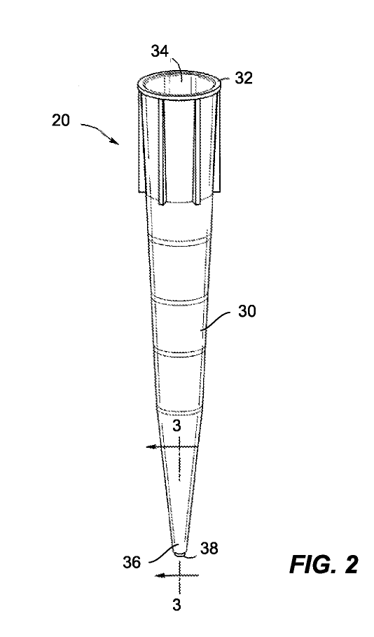

As shown in FIG. 2, the improved pipette tip assembly 20 comprises a hollow tip 30 having an open proximal end 32 with an opening 34, which end 32 and which opening 34 are adapted to receive the distal end of the pipette tip mounting shaft 22 of the pipette 10. The tip 30 also includes an open distal end 36, here depicted as being frusto-conical in shape, defining an opening 38 for passing fluid into and out of the pipette tip assembly 20 upon operation of the pipette 10 of FIG. 1. As illustrated, the pipette tip 30 is generally conical in shape, with the proximal end 32 having a larger diameter than the distal end 36. The tip 30 may be made of any of a variety of materials, including plastics such as polyolefins including polyethylene, polypropylene, polyethylene-terephthalate, and polytetrafluoroehtylene.

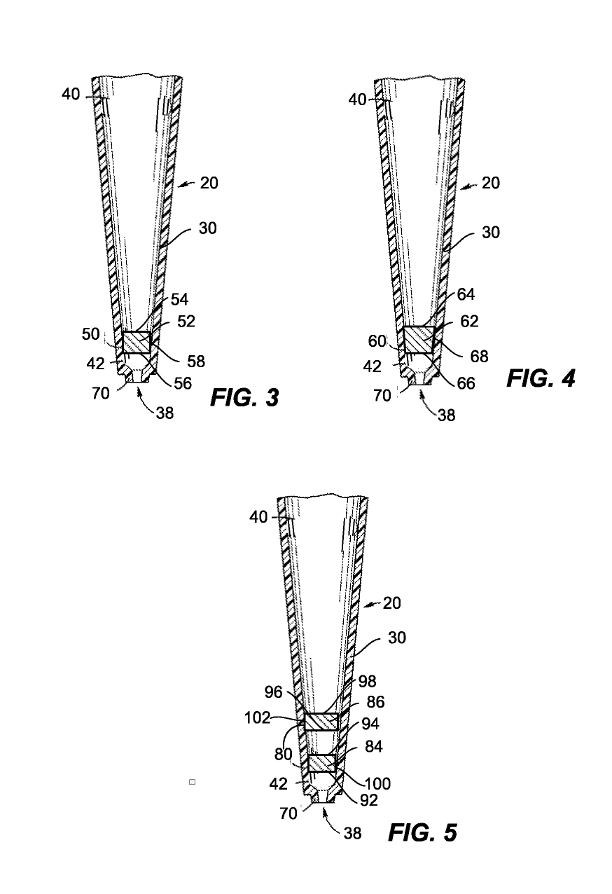

As illustrated in FIG. 3, the inside of the tip 30 is hollow and defines an open channel 40 between the ends 32, 36 for passing fluid from the opening 38 upward within the tip 30 in response to a vacuum pressure generated by the associated pipette 10 during the aspiration mode of operation of the pipette. In this regard, the open channel 40 for receiving such fluid is defined by an inner sidewall 42 of the tip 30. As seen in FIG. 3, the inner sidewall 42 is tapered to define a conical shape, although the inner sidewall 42 could be formed to take other shapes as well.

In the embodiment of the pipette tip assembly 20 illustrated in FIGS. 2 and 3, a porous mixer 50 is disposed in the channel 40. The mixer 50 may include at least one mixing device 52. As illustrated, the mixer 50 includes only one mixing device 52.

The mixing device 52 illustrated in FIG. 3 is a disc of material having a cylindrical shape, and thus having a generally circular cross-section in a plane orthogonal to the plane of the page. As a consequence, the mixing device 52 has end surfaces 54, 56 that are generally parallel with each other, and a side surface 58 that is at right angles to the end surfaces 54, 56. As a consequence, the side surface 58 appears as roughly parallel lines as illustrated in the cross-section of FIG. 3, as opposed to the inner side wall 42 of the tip 30 that appears as a pair of converging lines in the cross-section of FIG. 3. The diameter of the end surface 56 may be selected so that when the device 52 is secured in the channel 40 it is spaced from the opening 38, as illustrated, although this need not be the case in all embodiments according to the present disclosure.

In fact, in the embodiment illustrated in FIG. 4, the mixer includes a mixing device that has a non-cylindrical shape. Particularly, a mixer 60 includes a mixing device 62 that is tapered to define a conical shape, like the sidewall 42 of the tip 30. Thus, the mixing device 62 has end surfaces 64, 66 that are generally parallel with each other, and a side surface 68 that converges from the end surface 64 in the direction of the end surface 66. As a consequence, the side surface 68 appears as a pair of converging lines in the cross-section of FIG. 4. The taper of the side surface 68 (the rate at which the side surface converges from the end 64 to the end 66) may be selected such that the device 62 is secured in the channel 40 spaced from the opening 38, as illustrated, although this need not be the case in all embodiments according to the present disclosure.

In fact, the mixing device may have a variety of shapes, and is not limited to the cylindrical and conical geometries illustrated. For example, the end or side surface(s) of the mixing device may be curved, concave, or convex. As a still further alternative, the mixing device may have a teardrop shape, or may be spherical, spheroidical, or ellipsoidical, like a ball, a bead or an egg. Still other alternatives are possible.

Returning then to the embodiment illustrated in FIG. 3, the mixing device 52 is disposed and secured in the channel 40 against movement relative to the tip 30 by a press fit. That is, the mixing device 52 is disposed in the channel 40 and a force is applied to the mixing device 52, for example the surface 54, to engage the side surface 58 of the mixing device 52 with the inner side wall 42 of the tip 30. As a consequence, the mixing device 52 will remain in position to permit fluid to be drawn through the mixing device 52 into the pipette tip 30, and then expelled therefrom.

To permit a tight press fit, the diameter of the end surface 56 of the device 52 is chosen such that the engagement between the device 52 and the sidewall 42 of the tip 30 occurs some distance from the end 36 of the tip 30. This is to prevent the surface 56 from abutting an inwardly-depending rim 70 that is disposed about the opening 38, which rim 70 might resist the force applied to the mixing device 52. It will be recognized that such resistance may otherwise prevent a suitable press fit from being formed, such that the device 52 is not secured within the channel 40. According to other embodiments, it may be acceptable to have the device abutting the rim 70.

It will be understood that the mixing device 52 may eventually separate from the sidewall 42 with repeated use of the pipette tip assembly 20. Consequently, while the device 52 has been discussed as being secured within the channel 40 such that it does not move relative to the tip 30, this is not intended to suggest that the device will never detach, simply that the press fit applied is expected to maintain the device 52 within the tip 30 for a reasonable number of draw-expel cycles such that it will be of suitable for use as a mixing device. It will thus be understood that such a suitable use as a mixing device could occur where two separate fluids are drawn from a container into the tip 30, and then expelled in a mixed form.

Further, it will be understood that while the illustrated embodiment of FIG. 3 relies on a press fit to secure the device 52 in the tip 30, other mechanisms may be used to secure the mixer 50 to the tip 30. For example, an adhesive may be applied to the side surface 58 of the device 52 to secure it in place. As a further alternative, the inner sidewall 42 of the tip 30 may have ribs or threads that depend into the channel 40, and the device 52 may be disposed between a pair of such spaced ribs or the side surface 58 of the device 52 may engage the ribs or threads on the sidewall 42.

As a still further alternative, the device 52 may be disposed with a press fit into the tip 30, and a locking ring or plate disposed into the channel 40 as well, the locking ring secured to the side wall 42 to further ensure that the device 52 is secured in the tip 30. It will be recognized that such a locking ring or plate could be used in substitution for press fitting the device 52 into position along the channel 40, as well as in combination with such a press fit or an adhesive bonding of the device 52 to the sidewall 42. Such a locking ring or plate would need to have one or more passages therethrough to permit fluid to pass through the device 52 into and out of the tip assembly 20. Obviously, a locking ring may have a single hole, while a locking plate may have a perforated wall that permits passage through many holes.

As a still further possibility, the mixing device 52 may be introduced into the channel 40 of the tip 30 during the molding of the tip 30 while the tip 30 is still warm. According to such an embodiment, by introducing the mixing device 52 into the tip 30 while the tip 30 is still warm, it may be possible to accommodate mixing device shapes that would be difficult, if not impossible, to accommodate within the channel 40 after the tip 30 cools. Moreover, by introducing the mixing device 52 at that point in the process, the wall of the tip 30 may more completely conform to the shape of the device 52 to ensure that fluid will pass through the device 52 as opposed to around the device 52.

The mixing device 52 may be defined by a three-dimensional lattice or matrix that defines a plurality of tortuous, interconnecting passages therethrough. The porous mixing device 52 may have physical characteristics that include a selected one or more of mean flow pore size, thickness and porosity. As a result of three-dimensional lattice structure with tortuous, interconnecting passages, the components are intimately mixed together as they pass through the porous mixing device(s) 52 of the mixer 50. The mixer 50 may provide for a laminar flow of the components to enhance mixing between the components. Alternatively, the mixer may provide other flow conditions that preferably promote significant mixing of the components.

It will be recognized at the outset that the characteristics of the material selected for the porous mixing device 52 may depend on the specifications of the fluids to be mixed, such as viscosity and volume, so as to fulfill the requirements of the pipette such as time for pipetting, backpressure, and so on. In addition, the shape of the mixing device 52 may also be selected to accommodate the fluid dynamics requirements and the design of the tip assembly 20.

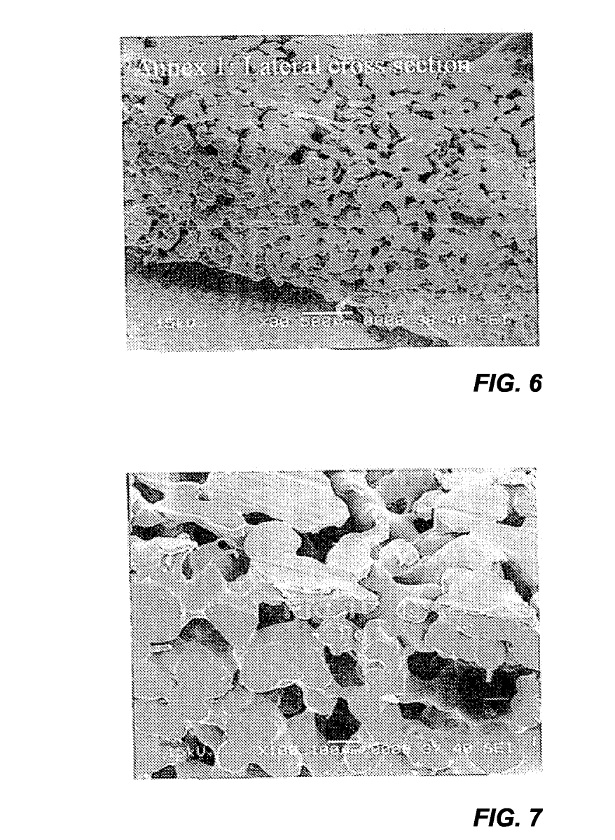

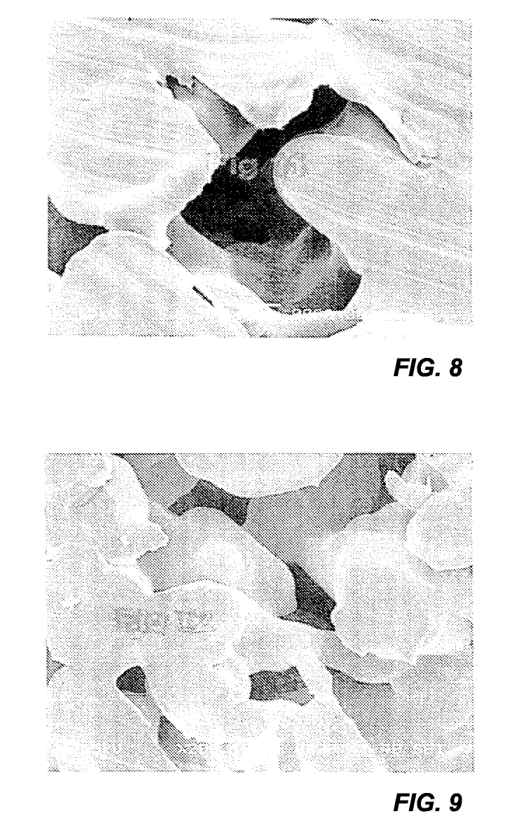

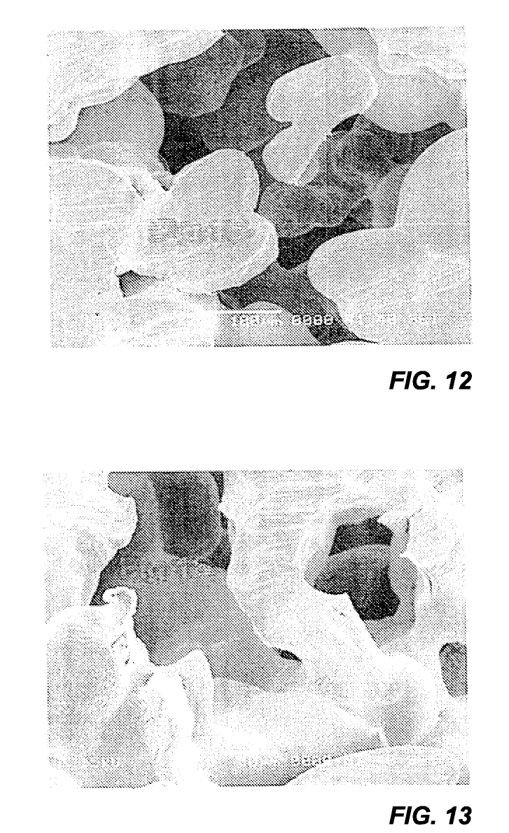

As to the nature of the materials that may be used, this is explained in greater detail in U.S. Publication No. 2009/0038701, which is hereby incorporated by reference herein for all purposes. However, one preferred material for the mixing devices 52 is illustrated in cross-sections in FIGS. 6-13. The material shown there is a polymeric material formed by sintering to define an integral porous structure. The lattice or matrix of polymeric material forms a plurality of essentially randomly-shaped, tortuous interconnected passageways through the mixer. The material of the mixing devices 52 may be selected, for example, from one or more of the following: Polyethylene (PE), High Density Polyethylene (HDPE), Polypropylene (PP), Ultra High Molecular Weight Polyethylene (UHMWPE), Nylon, Polytetra Fluoro Ethylene (PTFE), PVdF, Polyester, Cyclic Olefin Copolymer (COC), Thermoplastic Elastomers (TPE) including EVA, Polyethyl Ether Ketone (PEEK), polymer materials other than polyethylene or polypropylene or other similar materials. The mixing devices 52 may also be made of a polymer material that contains an active powdered material such as carbon granules or calcium phosphate granules with absorbed molecules. A sintered polypropylene material suitable for use in the present assemblies may be available from commercial sources, such as from Bio-Rad Laboratories, Richmond, Calif., United States; Porex Porous Products Group of Porex Manufacturing, Fairburn, Ga., United States; Porvair Technology, a Division of Porvair Filtration Group Ltd., of Wrexham, United Kingdom (such as Porvair Vyon Porvent, PPF or PPHP materials); or MicroPore Plastics, Inc., of 5357 Royal Woods, Parkway, Tucker, Ga. 30084, http://www.microporeplastics.com/.

As a further alternative, the mixing device 52 may be defined by a three-dimensional lattice or matrix made of a polymer co-sintered with at least a second material. For example, the polymer (such as the VYON-F polypropylene material) may be co-sintered with silica, such as may be available from Porvair Technology of Wrexham, United Kingdom. According to such further embodiments, the silica may be blended with the polymeric material prior to co-sintering, or sintered on one or both sides of the mixing device. Additionally, others materials could be used instead of silica; for example, mineral materials such as hydroxyapatite, insoluble calcium phosphate, glass, and quartz may be used.

Other materials that may be sintered to define an integral porous structure may include glasses, ceramics, and metals. In regard to metals, materials such as bronze, stainless steel, nickel, titanium, and related alloys may be used. Particular examples may include stainless steels, such as 316L, 304L, 310, 347, and 430, nickel alloys, such as HASTELLOY C-276, C-22, X, N, B, and B2 (HASTELLOY being a registered trademark of Haynes International, Inc. of Kokomo, Ind.), INCONEL 600, 625, 690, MONEL 400 (INCONEL and MONEL being registered trademarks of Huntington Alloys Corp of Huntington, W.Va.), Nickel 200 and Alloy 20, and titanium. Sintered metal materials suitable for use in the mixers and mixing methods of the present disclosure may be available from commercial sources, such as from Porvair Technology, a Division of Porvair Filtration Group Ltd., of Wrexham, United Kingdom (including BRM bronze materials); and Mott Corporation, of Farmington, Conn. (including stainless steels, nickel alloys (HASTEALLOY, INCONEL, MONEL, Nickel 200, Alloy 20) and titanium).

It is also possible that the mixing devices 52 may be made of one or more materials having one or more characteristics that may assist in the mixing of the component streams. By way of example and not limitation, the material may be hydrophilic (one which that essentially absorbs or binds with water), hydrophobic (one which is essentially incapable of dissolving in water), oleophobic (one which is essentially resistant to absorption of oils and the like), and/or have other characteristics that may be desired to enhance mixing of the components.

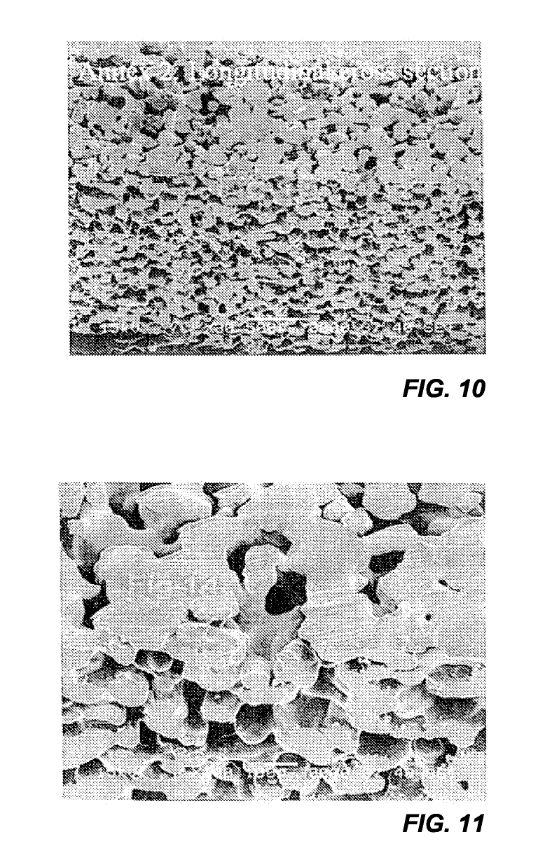

As noted above, the mixing devices 52 are preferably defined, either in whole or in part, by a three-dimensional lattice or matrix that defines a plurality of tortuous, interconnecting passages therethrough. In FIGS. 6-13, the streams of the components may pass through the illustrated three-dimensional lattice or matrix that defines a plurality of tortuous, interconnecting passages so that the component streams are thoroughly mixed to create an essentially homogeneous combined fluid stream. At FIGS. 6-9, scanning electron pictures show lateral sections respectively at about ×30, ×100, ×350 and ×200 magnifications for a sintered polypropylene material having a width of approximately 8.0 millimeters (mm) and a thickness of about 1.0 mm. At FIGS. 10-13, scanning electron pictures show a longitudinal section respectively at about ×30, ×100, ×250 and ×350 magnifications for the same material shown in FIGS. 6-9, illustrating other views of the three-dimensional lattice. As shown in FIGS. 6-13, the illustrated passages preferably intersect at one or more random locations throughout the mixing devices 52 such that the two component streams are randomly combined at such locations as such streams flow through the mixer. It should be understood that the three-dimensional lattice or matrix may be formed in a variety of ways and is not limited to the random structure of a sintered polymeric material as shown in FIGS. 6-13.

The illustrated mixing devices 52 are made of a porous material and may have varying porosity depending on the application. Such porous material preferably has a porosity that allows the streams of the components to pass through to create a thoroughly-mixed combined fluid stream. The porosity of a material may be expressed as a percentage ratio of the void volume to the total volume of the material. The porosity of a material may be selected depending on several factors including but not limited to the material employed and its resistance to fluid flow (creation of excessive back pressure due to flow resistance should normally be avoided), the viscosity and other characteristics and number of mixing components employed, the quality of mixing that is desired, and the desired application and/or work surface.

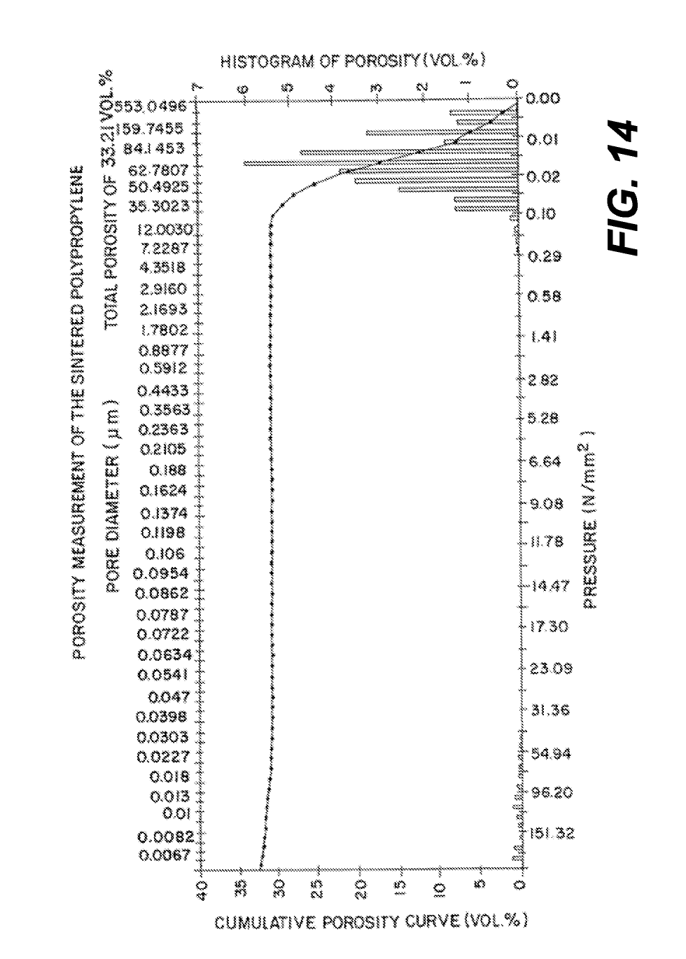

At FIG. 14, porosity measurements of a selected material, manufactured by Bio-Rad Laboratories, are shown as obtained using a mercury porosity test on an Autopore IIII apparatus, a product manufactured by Micromeritics of Norcross, Ga. It may also be possible to determine the porosity of a selected material in other ways or using other tests. At FIG. 14, such porosity measurements show the total volume of mercury intrusion into a material sample to provide a porosity of about 33%, an apparent density of about 0.66 and an average pore diameter of about 64.75 microns.

In addition, the mean pore size range of the mixing devices 52 may vary. In the three-dimensional lattice shown in FIGS. 6-13, the mixing devices 52 may define a plurality a pores that define at least a portion of the flow paths through which the streams of the components flow. The range of mean pore sizes may be selected to avoid undue resistance to fluid flow of such component streams. Further, the mean pore size range may vary depending on several factors including those discussed above relative to porosity.

Several mean pore size ranges for different materials that may be used in the mixing devices 52 are shown in Table 1, except at no. 16 which includes a “control” example that lacks a mixer.

TABLE 1
PART III: Evaluation of single porous disks
Materials from Porvent and Porex

| Sample | | | | Mean Pore | | | |
|---|---|---|---|---|---|---|---|
| ID | Type | Form | Property | Size | | Thickness | Mixing |
| 2 | | PE sheet | Hydrophobic | 5-55 | μm | 2.0 mm | Good |
| 21 | | PP sheet | Hydrophobic | 15->300 | μm | 2.0 mm | Good |
| 6 | | PE sheet | Hydrophobic | 20-60 | μm | 3.0 mm | Good |
| 19 | | PP sheet | Hydrophobic | 70-210 | μm | 1.5 mm | Good |
| 22 | | PP sheet | Hydrophobic | 70-140 | μm | 3.0 mm | Good |
| 24 | | PP sheet | Hydrophobic | 125-175 | μm | 3.0 mm | Good |
| 1 | | | Hydrophobic | 7-12 | μm | 1.5 mm | no fibrin |
| | | | | | | | extrusion |
| 8 | | PE sheet | Hydrophobic | 40-90 | μm | 1.5 mm | Good |
| 7 | | PE sheet | Hydrophobic | 20-60 | μm | 1.5 mm | Good |
| 9 | | PE sheet | Hydrophobic | 20-60 | μm | 3.0 mm | Good |
| 16 | | PE sheet | Hydrophobic | 40-100 | μm | 1.5 mm | Good |
| 18 | | PE sheet | Hydrophobic | 40-100 | μm | 3.0 mm | Good |
| 20 | | PE sheet | Hydrophobic | 80-130 | μm | 3.0 mm | Good |
| 14 | | PE sheet | Hydrophobic | 20-60 | μm | 1.5 mm | Good |
| 17 | | PE sheet | Hydrophobic | 80-130 | μm | 1.5 mm | Good |
| 26 | Control | — | — | — | | — | — |
| 27 | | PP sheet | Hydrophobic | 7-145 | μm | 1.5 mm | Good |

Table 1 includes several commercial sintered polyethylene (PE) or polypropylene (PP) materials manufactured by Porex or by Porvair under the tradename Porvent or Vyon. The table summarizes the mixing results achieved from each material based on quality of fibrin obtained after fibrinogen and thrombin (4 International Units (IU)/ml) passed through a device having a single mixing device, except for one experiment (at ID 26) which is the control and lacks any mixer. The indicated mean pore size ranges vary between about 5 and 300 microns. In Table 1, the ranges for materials nos. 2, 21, 6, 19, 22, 24, 8-9, 16, 18, 20, 14, 17, and 27 each generally indicate good mixing quality for fibrin. In Table 1, such mean pore size ranges are not intended to be exhaustive and other mean pore size ranges are also possible and useful for mixing. The mean pore size ranges indicated in Table 1 were obtained from the technical data sheets of the listed materials provided by the suppliers Porvair and Porex.

It may also be possible to characterize the mixing devices in other ways. For example, as discussed in U.S. Publication No. 2009/0038701, which is incorporated by reference herein for all purposes, as mentioned above, the mixing device's permeability, K, may be described according to Darcy's Law. According to the present disclosure, the mixing devices suitable for use in the pipette tip may have K values within the range of 5 to 250, although this by way of example only, and is not intended to limit the present disclosure to this particular range.

The mixing device 52 may be further configured and sized so as to provide sufficiently thorough mixing of the streams of the components. The size of the mixing device 52 may vary depending on such factors which include the size and/or configuration of the tip 30, the type of material used for the mixing devices 52, the porosity and mean pore size of the material used for the mixing devices 52, the desired degree of mixing, the components to be mixed, and/or the desired application. For mixing devices 52 having the above discussed example ranges for porosity and mean pore sizes, the thickness of the individual devices 52 may range between about 1.5 mm and 3.0 mm, as indicated in Table 1. Other thicknesses are also possible, including a variable or non-uniform thickness.

While the discussion of the mixers 50, 60 above was in regard to an embodiment that includes a single mixing device 52, 62, it will be recognized that the mixer according to the present disclosure may include more than one mixing device 52, 62. For example, an embodiment of a mixer 80 including more than one mixing device 82, 84 is illustrated in FIG. 5. As illustrated, the mixer 80 includes two mixing devices 82, 84.

While the mixing devices 82, 84 selected for the mixer 80 both have cylindrical geometries, this is exemplary only and should not be taken as limiting for such a multi-mixing device embodiment. As will be recognized, the mixing devices 82, 84 have end surfaces 92, 94, 96, 98 and side surfaces 100, 102. The diameters of the end surfaces 92, 96 of the mixing devices have been selected so that when the devices 82, 84 are press fit or otherwise secured in the channel 40 of the tip 30, the facing or opposing surfaces 94, 96 are spaced from each other by a distance. As a consequence, the surfaces 94, 96 and the sidewall 42 define a volume between the mixing devices 82, 84.

By spacing the mixing devices 82, 84 from each other, it is possible to develop a stop-and-go mixing process in the material being drawn into and expelled from the tip assembly 20. Such a stop-and-go mixing process is explained in greater detail in U.S. Publication No. 2009/0038701, which is incorporated by reference herein for all purposes, as mentioned above. In general terms, the movement of the fluids through the mixing device 82 into the volume between the devices 82, 84, and then through the mixing device 84, or along the reverse path, may enhance the combination of the fluids flowing therethrough.

In fact, the volume defined between the mixing devices 82, 84 may be filled with one of the two or more components to be mixed, thereby immobilizing the component therein. In this regard, see U.S. application Ser. No. 12/415,491, which is incorporated by reference herein for all purposes. In the alternative or in addition, one or more component may be adsorbed on the surface of the mixing device 82, 84 or in the passages of its porous structure. In this regard, also see the incorporated '491 application, which also includes various different embodiments and variants wherein one or more components are immobilized on or in the mixing devices.

Alternatively, the mixing devices 82, 84 may be disposed in the channel 40 such that there is no volume defined therebetween, or at least no appreciable volume defined therebetween. The mixing devices 82, 84 may be disposed in the channel 40 such that facing or opposing surfaces of the mixing devices 82, 84 abut each other. As a still further alternative, the mixing devices 82, 84 may be defined by different layers of a multilayer structure, which multilayer structure is formed as an integral structure (i.e., as a one piece). In this fashion, the mixing devices 82, 84 may be sandwiched together to define a mixer that has varying characteristics along the channel 40. For example, the mixing devices 82, 84 may have different pore sizes. Such embodiments and variants are within the scope of the present disclosure.

It should also be mentioned that the mixers 50, 60, and 80 may be disposed in a tip to be used in conjunction with other elements. For example, a filter may be disposed within the channel 40 to remove impurities in the fluids moving through the tip assembly 20, or to prevent the ingress or egress of liquid aerosols through the tip assembly 20. For example, U.S. Pat. No. 6,566,145 illustrates the inclusion of “frits” for filtering purposes, with the material contained in the tip being agitated in the tip to mix the material. U.S. Pat. No. 6,045,757 includes a porous plug in conjunction with a porous membrane to act as an aerosol barrier. The above-mentioned mixing devices may be used with the disclosure of either of these patents, which are hereby incorporated by reference in their entirety herein, while eliminating the need to agitate the tip, as described in the '145 patent, for example. Any of a number of different porous, fibrous or other elements may also be used in conjunction with a tip including a mixer according to the present disclosure.

The tip assemblies according to the present disclosure may be packaged and sold as items separate and apart from the pipette with which they are used. Alternatively, one or more of the tip assemblies may be packaged with a pipette, such as the pipette illustrated in FIG. 1, as a kit. It will also be recognized that the tip assemblies define part of a system with pipette to which they are attached when they are attached.

As for the operation of a pipette system according to the present disclosure, reference is made to FIG. 1 and the embodiment illustrated in FIG. 3, for example. The push button 14 is depressed to cause the piston of the pipette 10 to move downward. With the tip assembly 20 disposed in a container filled with a first liquid, the button 14 is released, causing a quantity of the first liquid to be drawn into the tip assembly 20. The tip assembly 20 is then moved over a container filled with a second liquid, and the button is depressed to cause the piston of the pipette 10 to move downward again. This causes the first liquid to be expelled into the same container as the second liquid. With the tip assembly 20 disposed in the container, the button 14 is manipulated to cause a portion of the quantity of the first liquid and the second liquid to be drawn into the tip assembly 20.

In doing so, the first and second liquids move through the mixer 50 as they are drawn through the opening 38 into the channel 40. The nature of the mixing device 52, with its three-dimensional porous profile, causes an enhanced blending of the two fluids, thereby mixing the first and second liquids as they enter the tip assembly 20. If desired, the mixed first and second liquids may be expelled from the tip assembly 20 of the pipette 10 by depressing the button 14, whereupon a second passage through the mixing device 52 will occur, which passage may further improve the mixing of the fluids. Alternatively, the fluids may be repeatedly expelled from and drawn into the tip assembly 20 to further mix the fluids before the mixture is finally expelled from the tip assembly 20.

According to a specific example of the present disclosure, first set of tests were conducted with a 2 ml pipette tip in which a mixer was disposed, the mixer including a single cylindrical mixing device, similar to the embodiment illustrated in FIG. 3. The mixing device had an end diameter of 3 mm and a thickness between the ends of 1.5 mm. The mixing device was made of a Porex material. The pipette used in the testing was manufactured by Socorex.

2 ml of water were drawn into and expelled from the tip, with some of the tests run with the mixing device as described above disposed in the tip and some of the tests run with the mixing device removed. The process was repeated five times with the device in place, and five times without the device. The water expelled from the tip was weighed for each test. While there were slight differences in the amounts expelled on each trial, there was no significant difference in the volume pipetted with the mixing device disposed in the tip and without, as reflected in Table 2.

TABLE 2

| | Amount (g) returned - | Amount (g) returned - |
|---|---|---|
| Test | tip without mixing device | tip with mixing device |
| 1 | 2.010 g | 2.016 g |
| 2 | 1.989 g | 1.990 g |
| 3 | 1.980 g | 1.983 g |
| 4 | 1.974 g | 1.980 g |
| 5 | 1.974 g | 1.973 g |
| Avg. | 1.985 g | 1.987 g |

A second set of tests were run wherein 2 ml of glycerol 87% at a viscosity of 115.7 cps were mixed with 2 ml of water using a pipette tip as described above relative to the first set of tests. Initially, the 2 ml of glycerol were pipetted into a clear container or tube, and then 2 ml of water were pipetted into the tube to form a layer on top of the glycerol. Rhodamin dye had been added to the water so that the mixing of the glycerol and the water could be evaluated visually. The tip of the pipette was then disposed into the contents of the tube, and a portion of the contents of the tube was drawn into the tip. The contents of the tip were then expelled back into the tube, and the process was repeated for a total of ten cycles. By the tenth cycle, the entire contents of the tube appeared to have a uniform purple color (caused by the rhodamin dye), while initially only the water layer on top of the glycerol had a purple color.

Consequently, according to an aspect of the present disclosure, a pipette tip assembly may include a pipette tip having a first open end adapted to receive a pipette tip mounting shaft of a pipette, a second open end, and an open channel therebetween. The assembly may also include a mixer disposed in the channel, the mixer including at least one porous mixing device. The at least one porous mixing device includes a three-dimensional lattice defining a plurality of tortuous, interconnecting passages therethrough, and has physical characteristics to sufficiently mix first and second fluids drawn or expelled through the mixer, which characteristics include a selected one or more of mean flow pore size, thickness and porosity.

According to second aspect of the present disclosure, a pipette system may include a pipette having a pipette tip mounting shaft and a pipette tip assembly. The pipette tip assembly may include a pipette tip having a first open end in which the pipette tip mounting shaft is disposed, a second open end, and an open channel therebetween. The assembly may also include a mixer disposed in the channel, the mixer including at least one porous mixing device. The at least one porous mixing device includes a three-dimensional lattice defining a plurality of tortuous, interconnecting passages therethrough, and has physical characteristics to sufficiently mix first and second fluids drawn or expelled through the mixer, which characteristics include a selected one or more of mean flow pore size, thickness and porosity

According to a third aspect of the present disclosure, a kit may include a pipette having a pipette tip mounting shaft and a pipette tip assembly. The assembly includes a pipette tip having a first open end adapted to receive the pipette tip mounting shaft. The pipette tip may also include a second open end and a channel therebetween. The pipette tip assembly may further include a mixer disposed in the channel, the mixer including at least one porous mixing device. The at least one porous mixing device includes a three-dimensional lattice defining a plurality of tortuous, interconnecting passages therethrough, and has physical characteristics to sufficiently mix first and second fluids drawn or expelled through the mixer, which characteristics include a selected one or more of mean flow pore size, thickness and porosity.

According to any of these three aspects of the present disclosure, the at least one mixing device may be disposed and secured in the channel of the pipette tip by a press fit. In such a case, the pipette tip may have an inner sidewall tapered to define a conical shape, and the at least one mixing device may have a cylindrical shape, or the pipette tip may have an inner sidewall tapered to define a conical shape, and the at least one mixing device may be tapered to define a conical shape. In addition, in combination with any of the foregoing, the at least one mixing device may include a sintered polymeric material, in particular a sintered polypropylene material.

According to another aspect of the present disclosure, a method of using a pipette tip assembly is provided. The pipette tip assembly includes a pipette tip. The pipette tip has a first open end adapted to receive a pipette tip mounting shaft of a pipette, a second open end, and an open channel therebetween, and a mixer disposed in the channel including at least one porous mixing device, the at least one porous mixing device comprising a three-dimensional lattice defining a plurality of tortuous, interconnecting passages therethrough, and having physical characteristics to sufficiently mix first and second fluids drawn or expelled through the mixer, which characteristics include a selected one or more of mean flow pore size, thickness and porosity. The method includes drawing a quantity of a first liquid from a first container into the tip assembly, expelling the quantity of the first liquid into a second container filled with a second liquid, and drawing a quantity of the first and second liquids from the second container, wherein the first and second liquids move through the mixer to mix the first and second liquids as they enter the tip assembly.

Additionally, the method may include expelling the mixed first and second liquids from the tip assembly, whereupon a second passage through the mixer and mixing of the mixed first and second liquids occurs. Further, the method may also include repeatedly expelling the mixed first and second liquids to further mix the first and second liquids before the mixed first and second liquids are finally expelled from the tip assembly.

It should be understood that various changes and modifications to the presently preferred embodiments described herein would be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A pipette tip assembly including:
a pipette tip having a first open end adapted to receive a pipette tip mounting shaft of a pipette, a second open end, and an open channel therebetween; and
a mixer disposed in the channel including at least one porous mixing device, the at least one porous mixing device comprising a three-dimensional lattice defining a plurality of tortuous, interconnecting passages therethrough, and having physical characteristics to sufficiently mix first and second fluids drawn or expelled through the mixer, which characteristics include a selected one or more of mean flow pore size, thickness and porosity.

2. The pipette tip assembly according to claim 1, wherein the pipette tip has an inner sidewall tapered to define a conical shape, and the at least one porous mixing device has a cylindrical shape.

3. The pipette tip assembly according to claim 1, wherein the pipette tip has an inner sidewall tapered to define a conical shape, and the at least one porous mixing device is tapered to define a conical shape.

4. The pipette tip assembly according to claim 1, wherein the mixer comprises two porous mixing devices with facing end surfaces that are spaced from each other by a distance to define a volume between the porous mixing devices.

5. The pipette tip assembly according to claim 4, wherein the volume is filled with a component to be mixed, immobilizing the component in the volume.

6. The pipette tip assembly according to claim 1, wherein the at least one porous mixing device comprises a porous material selected from the group consisting of polymer, glass, ceramic and metal.

7. The pipette tip assembly according to claim 6, wherein the at least one porous mixing device comprises a sintered material.

8. The pipette tip assembly according to claim 7, wherein the at least one porous mixing device is co-sintered with at least a second material.

9. The pipette tip assembly according to claim 8, wherein the second material is selected from the group consisting of silica, hydroxyapatite, insoluble calcium phosphate, glass and quartz.

10. The pipette tip assembly according to claim 7, wherein the at least one porous mixing device comprises a material selected from polypropylene or polyethylene.

11. The pipette tip assembly according to claim 1, wherein the at least one porous mixing device is disposed and secured in the channel of the pipette tip by a press fit.

12. A system comprising:
a pipette having a pipette tip mounting shaft: and
a pipette tip assembly including a pipette tip having an first open end in which the pipette tip mounting shaft is disposed, a second open end, and a channel therebetween, and a mixer disposed in the channel including at least one porous mixing device, the at least one porous mixing device comprising a three-dimensional lattice defining a plurality of tortuous, interconnecting passages therethrough, and having physical characteristics to sufficiently mix first and second fluids drawn or expelled through the mixer, which characteristics include a selected one or more of mean flow pore size, thickness and porosity.

13. The pipette system according to claim 12, wherein the pipette tip has an inner sidewall tapered to define a conical shape, and the at least one porous mixing device has a cylindrical shape.

14. The pipette system according to claim 12, wherein the pipette tip has an inner sidewall tapered to define a conical shape, and the at least one porous mixing device is tapered to define a conical shape.

15. A kit comprising:
a pipette having a pipette tip mounting shaft; and
a pipette tip assembly including a pipette tip having an first open end adapted to receive the pipette tip mounting shaft, a second open end, and a channel therebetween, and a mixer disposed in the channel including at least one porous mixing device, the at least one porous mixing device comprising a three-dimensional lattice defining a plurality of tortuous, interconnecting passages therethrough, and having physical characteristics to sufficiently mix first and second fluids drawn or expelled through the mixer, which characteristics include a selected one or more of mean flow pore size, thickness and porosity.

16. The kit according to claim 15, wherein the pipette tip has an inner sidewall tapered to define a conical shape, and the at least one porous mixing device has a cylindrical shape.

17. The kit according to claim 15, wherein the pipette tip has an inner sidewall tapered to define a conical shape, and the at least one porous mixing device is tapered to define a conical shape.
